(19) United States
(12) Patent Application Publication
(10) Pub. No.: US 2016/0271581 A1
(43) Pub. Date: Sep. 22, 2016

(54) METHOD FOR REMOVING MICROCYSTINS FROM AN AQUEOUS SOLUTION USING PARTICLES HAVING A REACTIVE THIOL FUNCTIONAL GROUP

(71) Applicant: ABS MATERIALS, INC., Wooster, OH (US)

(72) Inventor: Paul L. EDMISTON, Wooster, OH (US)

(21) Appl. No.: 15/076,525

(22) Filed: Mar. 21, 2016

Related U.S. Application Data
(60) Provisional application No. 62/135,566, filed on Mar. 19, 2015.

(51) Int. Cl. B01J 20/22; B01D 15/20; C02F 1/28; B01J 20/28; B01J 20/291

(52) U.S. Cl. CPC B01J 20/22; B01J 20/28047; B01J 20/28061; B01J 20/28071; B01J 20/291; C02F 1/288; B01D 15/20; B01J 2220/52; B01J 2220/44; C02F 2101/30

(57) ABSTRACT

Disclosed in a method for removing microcystins from an aqueous solution containing microcystins comprising contacting an aqueous solution containing microcystins with particles containing reactive thiol functional groups under conditions sufficient to reduce the concentration of microcystins in the aqueous solution.

### CROSS-REFERENCE TO RELATED APPLICATIONS

This application claims priority to U.S. Provisional Patent Application Ser. No. 62/135,566, entitled “METHOD FOR REMOVING MICROCYSTINS FROM AN AQUEOUS SOLUTION USING PARTICLES HAVING A REACTIVE THIOL FUNCTIONAL GROUP,” filed Mar. 19, 2015, which is expressly incorporated by reference herein in its entirety.

### BACKGROUND

1. Field of the Invention

The present invention relates generally to the chemical arts. More particularly, the invention relates to a method for removing microcystins from an aqueous solution.

2. Discussion of Related Art

Microcystins are class of at least 50 monocyclic heptapeptides produced by freshwater cyanobacteria such as Microcystis aeruginosa. Microcystins are micropollutants of concern for drinking water plants that draw from surface water sources. One of the difficulties of removing microcystins is that they are typically present in concentrations of 1 ppm or less.

### SUMMARY OF THE INVENTION

Now in accordance with the invention there has been discovered a method for reducing the concentration of microcystins from aqueous solution containing microcystins In one aspect the concentration of microcystins in the aqueous solution containing microcystins is 10 ppm or less prior to reduction and in one aspect, the concentration of microcystins in the aqueous solution containing microcystins is 1 ppm or less prior to reduction. In one aspect, the concentration of microcystins in the aqueous solution containing microcystins is reduced to less than 10 ppb and in one aspect, the concentration of microcystins in the aqueous solution containing microcystins is reduced to less than 1 ppb.

In another aspect, the particles containing reactive thiol functional groups are metal oxide particles, sand grains or polymer beads, and in one aspect, the particles containing reactive thiol functional groups are grains of water filter sand. In one aspect, the particles containing reactive thiol functional groups have a particle size of from about 10 micrometers to about 0.1 mm and, in one aspect, the particles containing reactive thiol functional groups have a particle size of from about 5.0 mm to about 1 mm.

In another aspect of the inventive method, the particles containing reactive thiol functional groups have a coating containing reactive thiol functional groups. In one aspect the coating is a sol-gel film formed from:

(a) from about 1 vol % to about 90 vol % of at least one first alkoxysilane precursor, where the at least one first alkoxysilane precursor has the formula:

(RO)ₓ(R₂)_{y}Si((R₁)Si(R₂)_{y}(OR)ₓ)_{z} (1)

where x is 2, 3 or 4, y is 0, 1 or 2 and z is 0 or 1, where the total of x+y+z is 4, and where each R is independently hydrogen or each R is independently a C₁ to C₅ alkyl, such as methyl or ethyl above, R₁ is an alkyl or aromatic bridging group and each R₂ is an organic group containing a reactive thiol.

(b) from about 99 vol % to about 10 vol % of at least one second alkoxysilane precursor, where the at least one second alkoxysilane precursor has the formula:

(RO)₃—Si—(CH₂)ₙ—Ar—(CH₂)ₘ—Si—(OR)₃ (2)

where n and m are individually an integer from 1 to 8, Ar is a single-, fused-, or poly-aromatic ring, such as a phenyl or naphthyl ring, and each R is independently an alkyl group as described above and,

(c) and from about 0 vol % to about 89 vol % at least third alkoxysilane precursor,
where the at least one third alkoxysilane precursor has the formula:

(RO)ₓ(R₃)_{y}Si((R₁)Si(R₃)_{y}(OR)ₓ)_{z} (3)

where each R₃ is independently an aliphatic or non-aliphatic hydrocarbon containing up to about 30 carbons, with or without one or more hetero atoms (e.g., sulfur, oxygen, nitrogen, phosphorous, and halogen atoms) or hetero atom-containing moieties and where the amounts of (a), (b) and (c) equal 100 vol % based on the total weight of the alkoxysilane precursors. And in one aspect, x is 2 or 3, y is 1 or 2 and z is 0, where the total of x+y is 4, and where each R2 is individually an organic group containing an reactive thiol. In another aspect, the sol-gel film is formed from about 80 vol % to about 50 vol % (a), from about 20 vol % to about 50 vol % (b) and from about and from about 0 vol % to about 30 vol % (c), where the amounts of (a), (b) and (c) equal 100 vol % based on the total weight of the alkoxysilane precursors containing microcystins is reduced to less than 1 ppb.

In one aspect, R₂ comprises straight-chain hydrocarbons, branched-chain hydrocarbons, cyclic hydrocarbons, and aromatic hydrocarbons and are unsubstituted or substituted. In some aspects, R₂ includes alkyl hydrocarbons, such as C₁-C₃ alkyls, and aromatic hydrocarbons, such as phenyl, and aromatic hydrocarbons substituted with heteroatom containing moieties, such —OH, —SH, —NH₂, and aromatic amines, such as pyridine. And in some aspects, R₂ comprises primary amines, such as aminopropyl, secondary amines, such as bis(triethoxysilylpropyl)amine, tertiary amines, isocyanates, such as isocyanopropyl, carbamates, such as propylbenzylcarbamate, alcohols, alkenes, pyridine, halogens, halogenated hydrocarbons or combinations thereof

In one aspect, the first alkoxysilane precursor comprises 3-mercaptopropyltrimethoxysilane. In another aspect, the second alkoxysilane precursor comprises bis(trialkoxysilylalkyl)benzenes. And in one aspect, the second alkoxysilane precursor comprises bis 1,4-bis(trimethoxysilylmethyl)benzene (BTB), bis(triethoxysilylethyl)benzene (BTEB), and mixtures thereof. In one aspect, the third alkoxysilane alkoxysilane precursor comprises tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl) pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysane, 3-cyanopropyltrimethoxysilane, 3-sulfoxypropyltrimethoxy silane, isocyanopropyltrimethoxysilane, 2-(3,4-epoxycyclohexyl)ethyltrimethoxysilane, isocyanopropyltrimethoxysilane and trimethoxypropylbenzylcarbamate.

In one aspect, the film has a surface area of from about 200 m²/g to about 500 m²/g. In another aspect, the film has a pore volume of from about 0.1 to about 0.5 mL/g.

### DETAILED DESCRIPTION OF THE PREFERRED EMBODIMENTS

Particular embodiments of the invention are described below in considerable detail for the purpose of illustrating its principles and operation. However, various modifications may be made, and the scope of the invention is not limited to the exemplary embodiments described below.

Unless otherwise described, all technical terms used herein have the same meaning as commonly understood by one of ordinary skill in the art to which the present invention pertains.

In accordance with the invention, there has been discovered a novel method for removing microcystins from an aqueous solution containing microcystins using particles containing reactive thiol functional groups. The method comprises contacting an aqueous solution containing microcystins with particles containing reactive thiol functional groups for a time to reduce the concentration of microcystins in the aqueous solution. In one aspect, the aqueous solution contains microcystins in a concentration of 10 ppm or less before treatment with the particles containing reactive thiol functional groups and in one aspect the aqueous solution contains microcystins in a concentration of 1 ppm or less before treatment.

It is an advantage of the invention that the aqueous solution containing microcystins can be contacted with the particles containing reactive thiol functional groups by any suitable method. In one aspect, the particles containing reactive thiol functional groups replace standard water filter sand used in conventional water filtsummaration equipment. It is another aspect of the invention that, after treatment with particles containing reactive thiol functional groups, the aqueous solution contains a concentration of microcystins that is less than 10 ppb and in one aspect, a concentration of microcystins that is less than 1 ppb.

It is an advantage of the invention that it can be used with any suitable particle containing at least one reactive group. In one aspect the particles are metal oxides, sand grains, polymer beads or the like. In one aspect, the particles have a particle size of from about 10 micrometers to about 0.1 mm. And in one aspect, the particles have a particle size of from about −5.0 mm to about 1 mm. In one aspect, the at least one reactive thiol functional group is covalently bound to the particle. In another aspect the at least one reactive thiol functional group is bound to the particle by other types of forces. In one embodiment, the reactive thiol functional group can be a part of a biomolecule, for example, such as a protein bound to a particle. For example, phosphatase type 1 has a reactive thiol functional group which specifically binds microcystins. Thus, in one embodiment, particles containing reactive thiol functional groups are comprised of phosphatase type 1 proteins attached to the surface of the particles.

In another aspect, the particle has a coating containing at least one reactive thiol functional groups. And in one aspect, the coating is a film. In one embodiment, the film is porous. And some embodiments, the porous film has a surface area of from about 200 m²/g to about 500 m²/g and in some embodiments the porous film has a surface area of from about 300 m²/g to about 400 m²/g. In some embodiments, the porous film has a pore volume of from about 0.1 to about 0.5 mL/g and in some embodiments the porous film has a surface area of from about 0.3 mL/g to about 0.4 mL/g.

In one aspect, particles of use in the inventive method contain a porous sol gel coating. And in one aspect, the porous sol-gel film formed from a mixture of alkoxysilane precursors. In one aspect, the sol-gel film is formed from:

(a), at least one first alkoxysilane precursor, where the at least one first alkoxysilane precursor has the formula:

(RO)ₓ(R₂)_{y}Si((R₁)Si(R₂)_{y}(OR)ₓ)_{z} (1)

where x is 2, 3 or 4, y is 0, 1 or 2 and z is 0 or 1, where the total of x+y+z is 4, and where each R is independently hydrogen or each R is independently a C₁ to C₅ alkyl, such as methyl or ethyl above, R₁ is an alkyl or aromatic bridging group and each R₂ is an organic group containing a reactive thiol. And in some aspects, x is 2 or 3, y is 1 or 2 and z is 0, where the total of x+y is 4, and where each R is independently an alkyl group as described above and each R₂ is individually an organic group containing an reactive thiol,

(b) at least one second alkoxysilane precursor, where the at least one second alkoxysilane precursor has the formula:

(RO)₃—Si—(CH₂)ₙ—Ar—(CH₂)ₘ—Si—(OR)₃ (2)

where n and m are individually an integer from 1 to 8, Ar is a single-, fused-, or poly-aromatic ring, such as a phenyl or naphthyl ring, and each R is independently an alkyl group as described above and, optionally,

(d) at least third alkoxysilane precursor, where the at least one third alkoxysilane precursor has the formula:

(RO)ₓ(R₃)_{y}Si((R₁)Si(R₃)_{y}(OR)ₓ)_{z} (3)

where x, y, R and R₁ are as defined above and each R₃ is independently an aliphatic or non-aliphatic hydrocarbon containing up to about 30 carbons, with or without one or more hetero atoms (e.g., sulfur, oxygen, nitrogen, phosphorous, and halogen atoms) or hetero atom-containing moieties. Representative R₂'s include straight-chain hydrocarbons, branched-chain hydrocarbons, cyclic hydrocarbons, and aromatic hydrocarbons and are unsubstituted or substituted. In some aspects, R₂ includes alkyl hydrocarbons, such as C₁-C₃ alkyls, and aromatic hydrocarbons, such as phenyl, and aromatic hydrocarbons substituted with heteroatom containing moieties, such —OH, —SH, —NH₂, and aromatic amines, such as pyridine.

Representative substituents for R₂ include primary amines, such as aminopropyl, secondary amines, such as bis(triethoxysilylpropyl)amine, tertiary amines, isocyanates, such as isocyanopropyl, carbamates, such as propylbenzylcarbamate, alcohols, alkenes, pyridine, halogens, halogenated hydrocarbons or combinations thereof

Exemplary first alkoxysilane precursors include, without limitation, 3-mercaptopropyltrimethoxysilane

Exemplary second alkoxysilane precursors include, without limitation, bis(trialkoxysilylalkyl)benzenes, such as 1,4-bis(trimethoxysilylmethyl)benzene (BTB), bis(triethoxysilylethyl)benzene (BTEB), and mixtures thereof, with bis(triethoxysilylethyl)benzene being preferred.

In one aspect, the second alkoxysilane alkoxysilane precursor is dimethyldimethoxysilane, dimethyldiethoxysilane, phenyltrimethoxysilane or aminopropyltriethoxysilane.

Exemplary third alkoxysilane alkoxysilane precursors include, without limitation, tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxy silane, 3-sulfoxypropyltrimethoxysilane, isocyanopropyltrimethoxysilane, 2-(3,4-epoxycyclohexypethyltrimethoxysilane, isocyanopropyltrimethoxysilane and trimethoxypropylbenzylcarbamate.

In one aspect, the amounts of the alkoxysilane precursors are from about 1 vol % to about 90 vol % (a), from about 99 vol % to about 10 vol % (b) and from about 0 vol % to about 89 vol % (c), where the amounts of (a), (b) and (c) equal 100 vol % based on the total weight of the alkoxysilane precursors. And in one aspect, the relative amounts of the alkoxysilane precursors are from about 80 vol % to about 50 vol % (a), from about 20 vol % to about 50 vol % (b) and from about and from about 0 vol % to about 30 vol % (c), where the amounts of (a), (b) and (c) equal 100 vol % based on the total weight of the alkoxysilane precursors.

In one aspect, the particles containing reactive thiol functional groups can be made by forming a reaction medium containing the particles with the alkoxy silane precursors under acid or base sol-gel conditions, preferably base sol-gel conditions. In one embodiment, the reaction medium contains from about 90 wt. % to about 99.9 wt. % of the particles and from about 0.1 to about 10 wt. % of the mixture of alkoxysilane precursors. And in one embodiment, the mixture contains at least about 99.9 wt. % of the particles.

In one embodiment, the alkoxysilane precursor reaction medium contains from about 1 vol % to about 90 vol % (a), from about 99 vol % to about 10 vol % (b) and from about 0 vol % to about 89 vol % (c), where the amounts of (a), (b) and (c) equal 100 vol % based on the total weight of the alkoxysilane precursors. And in one aspect, the relative amounts of the alkoxysilane precursors are from about 80 vol % to about 50 vol % (a), from about 20 vol % to about 50 vol % (b) and from about and from about 0 vol % to about 30 vol % (c), where the amounts of the first, second and third alkoxy silane precursors equal 100 vol % based on the total weight of the alkoxysilane precursors. The relative amounts of the particles and the at least one first, second and third alkoxysilane precursors in the reaction medium will depend on the particular particles containing reactive thiol functional groups and the particular application for the resulting particles containing reactive thiol functional groups. The relative amounts will be readily determinable without undue experimentation.

The reaction medium includes a solvent for the alkoxysilane precursors. In some aspects, the solvent has a Dimoth-Reichart solvatochromism parameter (ET) between 170-205 kJ/mol. Suitable solvents include, without limitation, tetrahydrofuran (THF), acetone, dichloromethane/THF mixtures containing at least 15% by vol. THF, and THF/acetonitrile mixtures containing at least 50% by vol. THF. Of these exemplary solvents, THF is preferred. The alkoxysilane precursors are preferably present in the reaction medium at between about 0.25M and about 1M, more preferably between about 0.4M and about 0.8M, most preferably about 0.5 M.

A catalytic solution comprising a catalyst and water is rapidly added to the reaction medium to catalyze the hydrolysis and condensation of the alkoxysilane precursors, so that a sol gel coating is formed on the particles. Conditions for sol-gel reactions are well-known in the art and include the use of acid or base catalysts. Preferred conditions are those that use a base catalyst. Exemplary base catalysts include, without limitation, tetrabutyl ammonium fluoride (TBAF), fluoride salts, including but not limited to potassium fluoride, 1,5-diazabicyclo[4.3.0]non-5-ene (DBN), and alkylamines, including but not limited to propyl amines, of which TBAF is preferred.

As noted above, acid catalysts can be used to form sol-gel coatings, although acid catalysts are less preferred. Exemplary acid catalysts include, without limitation, any strong acid such as hydrochloric acid, phosphoric acid, sulfuric acid and the like.

In one aspect, water is present in the reaction medium at an amount so there is at least one half mole of water per mole of alkoxysilane groups in the alkoxysilane precursors. In one aspect, temperatures at polymerization can range from between the freezing point of the reaction medium up to the boiling point of the reaction medium. And in one aspect, the temperature range is from about 4° C. to about 50° C.

After gellation, the sol-gel coating is preferably aged for an amount of time suitable to induce syneresis, which is the shrinkage of the gel that accompanies solvent evaporation. The aging drives off much, but not necessarily all, of the solvent. While aging times vary depending upon the catalyst and solvent used to form the gel, aging is typically carried out for about 15 minutes up to about 10 days. In one aspect, aging is carried out for at least about 1 hour and, in one aspect, aging is carried out for about 2 to about 10 days. In one aspect, aging temperatures can range from between the freezing point of the solvent or solvent mixture up to the boiling point of the solvent or solvent mixture. And in one aspect, the aging temperature is from about 4° C. to about 50° C. And in some aspects, aging is carried out either in open atmosphere, under reduced pressure, in a container or oven.

After gellation, the sol-gel coating is characterized by the presence of residual silanols. In a preferred embodiment, the particles contain reactive —OH groups, such as the reactive —Si—OH groups contained on the surface of sand. In such embodiments, the reactive —Si—OH groups form covalent bonds with the residual silanols. In one embodiment, formation of the covalent bonds is facilitated by annealing the sol-gel coating to the surface of the particles containing reactive —OH groups at a temperature of from about 25° C. to about 180° C. and in some embodiments at a temperature of from about 75° C. to about 125° C.

### EXAMPLES

### Example 1

Removal of microcystins from water was done using an Agilent C18 high pressure liquid chromatography (HPLC) column. Elution was done running a linear gradient of 100% water to 55% acetonitrile: 45% water with UV detection at 242 nm with a flow rate of 0.25 mL/min. A 3.6 sample of thiol containing sol-gel film made by mixing 25 μL 3-mercapto- propyltriethoxysilane (MPTMS, thiol) and 475 μL bis(trimethoxysilylethyl)benzene (BTEB) in 50 mL acetone and adding 100 μL of a 0.05 M solution of tetrabutylammonium fluoride in water, allowing it to react and age 5 days, and depositing the solution onto 100 g of sand to create the coating. The final composition was 5% MPTMS relative to BTEB coated sand was mixed with 30 mL of water that contained 1 ppm microcystins. After a 22 min of mixing, >99% of the microcystins were removed from solution.

A control experiment was done with 3.2 g sand that was not modified with the thiol containing sol-gel film. After 22 min only 10% of the microcystins were removed. The sand was pool filter sand obtained from FairmountSantrol. The microcystins (purity >95%) were obtained from Spectrum Chemical and dissolved in deionized water.

### Example 2

Formation of the reversible thioether adduct was tested by rinsing the thiol containing sol-gel derived film coated sand with ethanol to displace the retained microcystins.

A column of 50 g thiol modified sand was prepared and 200 mL of water contaminated with 1 ppm microcystins were passed through the bed at 3 bed volumes per minute. Analysis of the water leaving the sand bed indicated >99% capture of the microcystins. Continual rinsing with water did not elute any microcystins indicating irreversible adsorption. By passing water containing microcystins through the bed the microcystins are removed and purified to a level that it is safe for human consumption. Covalently attached microcystins would not be removed by an ethanol rinse. It was found that only 3% of the microcystins were removed by ethanol rinse indicating irreversible attachment of a majority of the microcystins to the thiol modified particles.

I claim:

1. A method for removing microcystins from an aqueous solution containing microcystins comprising:
contacting an aqueous solution containing microcystins with particles containing reactive thiol functional groups under conditions sufficient to reduce the concentration of microcystins in the aqueous solution.

2. The method of claim 1 wherein the concentration of microcystins in the aqueous solution containing microcystins is 10 ppm or less prior to reduction.

3. The method of claim 2 wherein the concentration of microcystins in the aqueous solution containing microcystins is 1 ppm or less prior to reduction.

4. The method of claim 2 wherein the concentration of microcystins in the aqueous solution containing microcystins is reduced to less than 10 ppb.

5. The method of claim 4 wherein the concentration of microcystins in the aqueous solution containing microcystins is reduced to less than 1 ppb.

6. The method of claim 1 wherein the particles containing reactive thiol functional groups are metal oxide particles, sand grains or polymer beads.

7. The method of claim 1 wherein the particles containing reactive thiol functional groups are grains of water filter sand.

8. The method of claim 7 wherein the particles containing reactive thiol functional groups have a particle size of from about 10 micrometers to about 0.1 mm.

9. The method of claim 1 wherein the particles containing reactive thiol functional groups have a coating containing reactive thiol functional groups.

10. The method of claim 1 wherein the coating is a sol-gel film formed from:
(a) from about 1 vol % to about 90 vol % of at least one first alkoxysilane precursor, where the at least one first alkoxysilane precursor has the formula:
(RO)ₓ(R₂)_{y}Si((R₁)Si(R₂)_{y}(OR)ₓ)_{z} (1)
where x is 2, 3 or 4, y is 0, 1 or 2 and z is 0 or 1, where the total of x+y+z is 4, and where each R is independently hydrogen or each R is independently a C₁ to C₅ alkyl, such as methyl or ethyl above, R₁ is an alkyl or aromatic bridging group and each R₂ is an organic group containing a reactive thiol.
(b) from about 99 vol % to about 10 vol % of at least one second alkoxysilane precursor, where the at least one second alkoxysilane precursor has the formula:
(RO)₃—Si—(CH₂)ₙ—Ar—(CH₂)ₘ—Si—(OR)₃ (2)
where n and m are individually an integer from 1 to 8, Ar is a single-, fused-, or poly-aromatic ring, such as a phenyl or naphthyl ring, and each R is independently an alkyl group as described above and,
(e) and from about 0 vol % to about 89 vol % at least third alkoxysilane precursor, where the at least one third alkoxysilane precursor has the formula:
(RO)ₓ(R₃)_{y}Si((R₁)Si(R₃)_{y}(OR)ₓ)_{z} (3)
where each R₃ is independently an aliphatic or non-aliphatic hydrocarbon containing up to about 30 carbons, with or without one or more hetero atoms (e.g., sulfur, oxygen, nitrogen, phosphorous, and halogen atoms) or hetero atom-containing moieties and where the amounts of (a), (b) and (c) equal 100 vol % based on the total weight of the alkoxysilane precursors.

11. The method of claim 10 where x is 2 or 3, y is 1 or 2 and z is 0, where the total of x+y is 4, and where each R₂ is individually an organic group containing an reactive thiol.

12. The method of claim 10 wherein the sol-gel film is formed from about 80 vol % to about 50 vol % (a), from about 20 vol % to about 50 vol % (b) and from about and from about 0 vol % to about 30 vol % (c), where the amounts of (a), (b) and (c) equal 100 vol % based on the total weight of the alkoxysilane precursors.

13. The method of claim 12 wherein R₂ comprises straight-chain hydrocarbons, branched-chain hydrocarbons, cyclic hydrocarbons, and aromatic hydrocarbons and are unsubstituted or substituted.

14. The method of claim 11 wherein R₂ comprises alkyl hydrocarbons, aromatic hydrocarbons, and aromatic hydrocarbons substituted with heteroatom containing moieties, such —OH, —SH, —NH₂, and aromatic amines, such as pyridine.

15. The method of claim 10 wherein the first alkoxysilane precursor comprises 3-mercaptopropyltrimethoxysilane.

16. The method of claim 10 where the second alkoxysilane precursor comprises bis(trialkoxysilylalkyl)benzenes.

17. The method of claim 16 where the second alkoxysilane precursor comprises bis 1,4-bis(trimethoxysilylmethyl)benzene (BTB), bis(triethoxysilylethyl)benzene (BTEB), and mixtures thereof.

18. The method of claim 10 wherein the third alkoxysilane alkoxysilane precursor comprises tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxysilane, 3-sulfoxypropyltrimethoxysilane, isocyanopropyltrimethoxysilane, 2-(3,4-epoxycyclohexyl)ethyltrimethoxysilane, isocyanopropyltrimethoxysilane and trimethoxypropylbenzylcarbamate.

19. The method of claim 10 wherein the film has a surface area of from about 200 m²/g to about 500 m²/g.

20. The method of claim 10 wherein the film has a pore volume of from about 0.1 to about 0.5 mL/g.
